(19) United States
(12) Patent Application Publication
(10) Pub. No.: US 2015/0073204 A1
(43) Pub. Date: Mar. 12, 2015

(54) INCUBATOR'S CANOPY WITH SENSOR DEPENDENT VARIABLY TRANSPARENT WALLS AND METHODS FOR DIMMING LIGHTS THEREOF

(71) Applicant: ASPECT IMAGING LTD., Shoham (IL)

(72) Inventor: Uri RAPOPORT, Moshav Ben Shemen (IL)

(21) Appl. No.: 14/453,909

(22) Filed: Aug. 7, 2014

Related U.S. Application Data
(60) Provisional application No. 61/991,749, filed on May 12, 2014.

(30) Foreign Application Priority Data
Sep. 2, 2013 (GB) 1315595.7

(51) Int. Cl. A61G 11/00; G02F 1/133; G02F 1/01

(52) U.S. Cl. CPC A61G 11/00; G02F 1/0121; G02F 1/13318
USPC 600/22

(57) ABSTRACT

An incubator with a canopy that selectively controls an amount of light that is transmitted into it. The incubator includes: at least one sensor configured to detect light transmitted into the incubator's capacity and to further convert the transmitted light into electrical current. The incubator also includes a canopy characterized by at least one portion, the portion comprises one or more smart incubator's glass (SIG); where the SIG is adapted to at least partially reduce or increase the light transparency via the portion in accordance with the sensor's electrical current.

### FIELD OF THE INVENTION

The present invention generally relates to an incubator's canopy with sensor dependent variably transparent walls and methods for dimming lights thereof.

### BACKGROUND OF THE INVENTION

Light environment should be taken into consideration in designing new models of incubators. See Antonucci et al., The infant incubator in the neonatal intensive care unit (NICU): unresolved issues and future developments. J Perinat Med. 2009; 37(6):587-98. In fact, ambient NICU illumination may cause visual pathway sequelae or possibly retinopathy of prematurity (ROP), while premature exposure to continuous lighting may adversely affect the rest-activity patterns of the newborn. Accordingly, both the use of incubator covers and circadian lighting in the NICU might attenuate these effects. The impact of electromagnetic fields (EMFs) on infant health is still unclear. However, future incubators should be designed to minimize the EMF exposure of the newborn; See Antonucci et al., The infant incubator in the neonatal intensive care unit: unresolved issues and future developments. J Perinat Med. 2009; 37(6):587-98.

Light is currently dimmed by mechanical means, like swiveled light shutters, dangerous means, such blankets which are to cover the infant's incubator . . . or just by dimming the room's light so as light do not disturb the sleeping infants yet enormously disturbing the medical personnel working adjacent the said incubator.

Various applicable standards and guidelines are incorporated herein as a reference, including IEC 601-2-19 Amendment I Medical Electrical Equipment—Part 2: Particular Requirements for Safety of Baby Incubators; IEC 601-2-20 Medical Electrical Equipment—Part 2: Particular Requirements for Safety of Transport Incubators; ISO 10993-1: 1992 Biological Evaluation of Medical Devices—Part 1: Evaluation and Testing; AAMI 1151-D-1994 Transport Infant Incubator (Draft Standard); AAMI/CDV-1 1136 1997 Infant Incubator (Draft Standard).

It is thus a long felt need to provide integrated safe means for dimming light in infant's incubators and increasing infant's wellbeing and rest.

### SUMMARY OF THE INVENTION

It is an object of the invention to disclose an incubator for dimming and undimming the light transmitted therein its capacity comprising at least one sensor configured to detect light transmitted into the incubator's capacity and to further convert this transmitted light into electrical current; and a canopy characterized by at least one portion which comprises one or more smart incubator's glass (SIG); wherein the SIG is adapted to at least partially reduce or increase the light transparency via said portion in accordance with the sensor's electrical current.

It is also in the scope of the present invention wherein the sensor may be configured to detect light in the range of visible light.

It is also in the scope of the present invention wherein the sensor may be further provided with a semi-permeable light filter.

It is also in the scope of the present invention wherein the SIG may be selected from a group consisting of electrochromic devices, suspended particle devices, polymer dispersed liquid crystal devices, micro-blinds, mechanical smart windows, nano-crystals and any combination thereof.

It is also in the scope of the present invention wherein the incubator is useful for eliminating visual pathway sequelae or retinopathy of prematurity (ROP) in a premature which was exposed to continuous lighting thereby adversely affecting the rest-activity patterns of the newborn.

It is also in the scope of the present invention wherein the incubator is operative by a method consisting steps of providing at least one photodiode configured to detect light transmitted into said incubator and to further convert said transmitted light into electrical current; and at least one portion of a premature incubator with a SIG-containing light-dimmable transparent canopy, envelope, window or wall thereof, accommodating a premature within said incubator, and dimming or undimming the light transparency in said portion in accordance with said electrical current such that sequelae or ROP is eliminated whilst the premature's rest is acquired.

It is another object of the invention to provide a method of dimming and undimming the light within an incubator, comprising reducing the light transparency of at least a portion of said incubator's canopy by providing said portion with one or more smart incubator's glass (SIG), and further providing a sensor detecting light transmitted into said incubator and converting said transmitted light into an electrical current, resulting in an alteration of electrical input supplied to said SIG, affecting the transparency of said portion, thereby dimming and undimming the light within said incubator.

It is also in the scope of the present invention wherein the method further comprises providing a sensor may be configured to detect light in the range of visible light.

It is also in the scope of the present invention wherein the method further comprises providing a sensor may be provided with a semi-permeable light filter.

It is also in the scope of the present invention wherein the method may further comprise selecting the SIG from a group consisting of electrochromic devices, suspended particle devices, polymer dispersed liquid crystal devices, micro-blinds, mechanical smart windows, nano-crystals and any combination thereof.

It is also in the scope of the present invention whereby the method is directed at eliminating visual pathway sequelae or retinopathy of prematurity (ROP), in a premature which was exposed to continuous lighting thereby adversely affecting the rest-activity patterns of the newborn; the method further comprises steps of accommodating a premature within said incubator, and dimming the light transparency in said portion as required such that sequelae or ROP is eliminated whilst premature's rest is acquired.

It is another object of the invention to disclose a system comprising of at least one sensor configured to detect light transmitted into said incubator and further convert said transmitted light into electrical current; and a canopy characterized by at least one portion, said portion comprises one or more smart incubator's glass (SIG); wherein said SIG is adapted to at least partially reduce or increase the light transparency via said portion in accordance with said electrical current.

It is also in the scope of the present invention wherein the above mentioned system's sensor may be configured to detect light in the range of visible light.

It is also in the scope of the present invention wherein the above mentioned system's sensor may be further provided with a semi-permeable light filter.

It is also in the scope of the present invention wherein the system comprised SIG may be selected from a group consisting of electrochromic devices, suspended particle devices, polymer dispersed liquid crystal devices, micro-blinds, mechanical smart windows, nano-crystals and any combination thereof.

It is another object of the invention to disclose an incubator for reducing or increasing heat therein its capacity comprising at least one sensor configured to measure temperature and to further convert said measured temperature into electrical current; and a canopy characterized by at least one portion, said portion comprises one or more smart incubator's glass (SIG); wherein said SIG is adapted to at least partially reduce or increase the light transparency via said portion in accordance with said sensor's electrical current.

It is also in the scope of the present invention wherein the sensor may be a skin temperature sensor.

It is also in the scope of the present invention wherein the sensor may be an incubator's capacity temperature sensor.

It is also in the scope of the present invention wherein the SIG may be selected from a group consisting of electrochromic devices, suspended particle devices, polymer dispersed liquid crystal devices, micro-blinds, mechanical smart windows, nano-crystals and any combination thereof.

It is also in the scope of the present invention wherein the heat overshoot in the incubator's capacity due to alterations in light transparency does not exceed 2° C. in accordance with ANSI/AAMI/IEC 60601-2-20: 2009.

It is another object of the invention to provide a method of reducing or increasing the heat within an incubator, reducing or increasing the light transparency of at least a portion of said incubator's canopy, comprising providing said portion with one or more smart incubator's glass (SIG); further providing a sensor for measuring temperature, and converting the measured temperature into an electrical current, resulting in an alteration of electrical input supplied to said SIG, affecting the transparency of said portion, thereby reducing or increasing the heat within said incubator.

It is also in the scope of the present invention wherein the above mentioned method may be further provided with selecting said SIG from a group consisting of electrochromic devices, suspended particle devices, polymer dispersed liquid crystal devices, micro-blinds, mechanical smart windows, nano-crystals and any combination thereof.

### BRIEF DESCRIPTION OF THE FIGURES

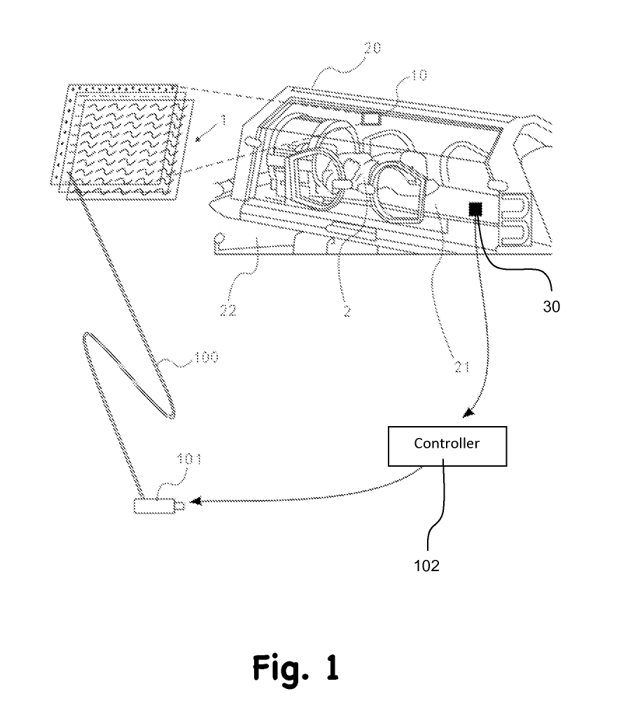

In order to understand the invention and to see how it may be implemented in practice, a few preferred embodiments will now be described, by way of non-limiting example only, with reference to the accompanying drawings, in which FIG. 1 illustrates in an artistic out-of-scale manner a smart incubator's glass (SIG) incorporated in at least one portion of a wall of neonate's incubator, the incubator further comprising at least one sensor configured to detect light or heat transmitted into said incubator's capacity and to further convert said transmitted light or measured temperature into electrical current, according to which the SIG's light transparency is adapted.

### DETAILED DESCRIPTION OF THE PREFERRED EMBODIMENTS

The term “smart incubator's glass” (SIG) refers herein after to one or more members of a group consisting of Electrochromic devices, Suspended particle devices, Polymer dispersed liquid crystal devices, Micro-blinds, Mechanical smart windows, Nanocrystals and combination thereof adapted to at least partially reduce the light transparency of neonate's incubators' canopies, windows or walls.

It is thus in the scope of the present invention wherein electrochromic devices are incorporated or comprised in or otherwise are in connection with an infant's incubator's canopy, and further adapted according to at least one sensor detecting light or heat, converting these parameters into electrical current. Electrochromic devices change light transmission properties in response to voltage and thus allow control over the amount of light and heat passing through.

According to an embodiment of the invention, in electrochromic canopy of incubators, the electrochromic material, as disclosed in Wikipedia, changes its opacity: it changes between a colored, translucent state (usually blue) and a transparent state. A burst of electricity is required for changing its opacity, but once the change has been effected, no electricity is needed for maintaining the particular shade which has been reached. Darkening occurs from the edges, moving inward, and is a slow process, ranging from many seconds to several minutes depending on window size. Still according to an embodiment of the invention, electrochromic glass provides visibility even in the darkened state and thus preserves visible contact with the outside environment.

Recent advances in electrochromic materials pertaining to transition-metal hydride electrochromics are incorporated, according to an embodiment of the invention, in incubator's wall as a reflective hydrides, which are reflective rather than absorbing, and thus switch states between transparent and mirror-like.

Still according to an embodiment of the invention, modified porous nano-crystalline films provides an electrochromic display. The single substrate display structure consists of several stacked porous layers printed on top of each other on a substrate modified with a transparent conductor (such as ITO or PEDOT:PSS). Each printed layer has a specific set of functions. A working electrode consists of a positive porous semiconductor (e.g., Titanium Dioxide, TiO2) with adsorbed chromogens (different chromogens for different colors). These chromogens change color by reduction or oxidation. Still according to an embodiment of the invention, a passivator is used as the negative of the image to improve electrical performance. The insulator layer serves the purpose of increasing the contrast ratio and separating the working electrode electrically from the counter electrode. Still according to an embodiment of the invention, the counter electrode provides a high capacitance to counterbalances the charge inserted/extracted on the SEG electrode (and maintain overall device charge neutrality). Carbon is an example of charge reservoir film. Still according to an embodiment of the invention, a conducting carbon layer is typically used as the conductive back contact for the counter electrode. In the last printing step, the porous monolith structure is overprinted with a liquid or polymer-gel electrolyte, dried, and then may be incorporated into various encapsulation or enclosures, depending on the application requirements. Displays are very thin, typically 30 micrometer, or about ⅓ of a human hair. The device can be switched on by applying an electrical potential to the transparent conducting substrate relative to the conductive carbon layer. This causes a reduction of viologen molecules (coloration) to occur inside the working electrode. By reversing the applied potential or providing a discharge path, the device bleaches. A unique feature of the electrochromic monolith is the relatively low voltage (around 1 Volt) needed to color or bleach the viologens. This can be explained by the small over-potentials needed to drive the electrochemical reduction of the surface adsorbed viologens/chromogens.

Still according to an embodiment of the invention, in suspended particle devices (SPDs), a thin film laminate of rod-like particles suspended in a fluid is placed between two glass or plastic layers, or attached to one layer. When no voltage is applied, the suspended particles are arranged in random orientations and tend to absorb light, so that the glass panel looks dark (or opaque), blue or, in more recent developments, grey or black colour. When voltage is applied, the suspended particles align and let light pass. SPDs can be manually or automatically “tuned” to precisely control the amount of light, glare and heat passing through, reducing the need for air conditioning during the summer months and heating during winter. Other advantages include reduction of buildings' carbon emissions and the elimination of a need for expensive window dressings.

Still according to an embodiment of the invention, in polymer dispersed liquid crystal devices (PDLCs), liquid crystals are dissolved or dispersed into a liquid polymer followed by solidification or curing of the polymer. During the change of the polymer from a liquid to solid, the liquid crystals become incompatible with the solid polymer and form droplets throughout the solid polymer. The curing conditions affect the size of the droplets that in turn affect the final operating properties of the “Smart Incubator Window”™ by Aspect Imaging Ltd (US). Typically, the liquid mix of polymer and liquid crystals is placed between two layers of glass or plastic that include a thin layer of a transparent, conductive material followed by curing of the polymer, thereby forming the basic sandwich structure of the smart window. This structure is in effect a capacitor.

Still according to an embodiment of the invention, electrodes from a power supply are attached to the transparent electrodes. With no applied voltage, the liquid crystals are randomly arranged in the droplets, resulting in scattering of light as it passes through the smart window assembly. This results in the translucent, “milky white” appearance. When a voltage is applied to the electrodes, the electric field formed between the two transparent electrodes on the glass causes the liquid crystals to align, allowing light to pass through the droplets with very little scattering and resulting in a transparent state. The degree of transparency can be controlled by the applied voltage. This is possible because at lower voltages, only a few of the liquid crystals align completely in the electric field, so only a small portion of the light passes through while most of the light is scattered. As the voltage is increased, fewer liquid crystals remain out of alignment, resulting in less light being scattered. It is also possible to control the amount of light and heat passing through, when tints and special inner layers are used. It is also possible to create fire-rated and anti X-Ray versions for use in special applications. Most of the devices offered today operate in on or off states only, even though the technology to provide for variable levels of transparency is easily applied. This technology has been used in interior and exterior settings for privacy control and as a temporary projection screen.

Still according to an embodiment of the invention, Micro-blinds, currently under development at the National Research Council (Canada), are used according to an embodiment of the invention in incubator's wall for the control the amount of light passing through in response to applied voltage. Still according to an embodiment of the invention, micro-blinds are composed of rolled thin metal blinds on glass. They are very small and thus practically invisible to the eye. The metal layer is deposited by magnetron sputtering and patterned by laser or lithography process. The glass substrate includes a thin layer of a transparent conductive oxide (TCO) layer. A thin insulator is deposited between the rolled metal layer and the TCO layer for electrical disconnection. With no applied voltage, the micro-blinds are rolled and let light pass through. When there is a potential difference between the rolled metal layer and the transparent conductive layer, the electric field formed between the two electrodes causes the rolled micro-blinds to stretch out and thus block light. The micro-blinds have several advantages including switching speed (milliseconds), UV durability, customized appearance and transmission. Theoretically, the blinds are simple and cost-effective to fabricate.

Still according to an embodiment of the invention, mechanical smart incubator's windows are utilized. This low cost alternative to high-tech intelligent windows is composed of two retro reflective panels mounted back-to-back with a narrow gap in between. When a liquid with the same refractive index as that of the panels is pumped into the cavity between them, the glass becomes transparent. When the liquid is pumped out, the glass turns retro reflective again.

Still according to an embodiment of the invention is a thin coating of nanocrystals embedded in glass which provide selective control over both visible light and heat-producing near-infrared (NIR) light independently climates. The technology employs, according to one aspect of this invention, a small jolt of electricity to switch the material between NIR-transmitting and NIR-blocking states. Still according to an embodiment of the invention, nanocrystals of indium tin oxide embedded in a glassy matrix of niobium oxide form a composite material. The voltage ranges over 2.5 volts. The same window can also be switched to a dark mode, blocking both light and heat, or to a bright, fully transparent mode. The effect relies on a synergistic interaction in the region where glassy matrix meets nanocrystal that increases the electrochromic effect. The atoms connect across the nanocrystal-glass interface, causing a structural rearrangement in the glass matrix. The interaction creates space inside the glass, allowing charge to move more readily.

Still according to an embodiment of the invention are PDLCs operate on the principle of electrically controlled light scattering. They consist of liquid crystal droplets surrounded by a polymer mixture sandwiched between two pieces of conducting glass. When incorporated within or on top of incubator's wall, and when no electricity is applied the liquid crystal droplets are randomly oriented, creating an opaque state. When electricity is applied the liquid crystals align parallel to the electric field and light passes through, creating a transparent state.

According to an embodiment of the invention, means and methods are disclosed for scattering a desired quantity of light from the light source and a control power supply for controlling a light scattering rate or effect of the liquid crystal dimmer plate as defined in U.S. Pat. No. 5,764,316 which is incorporated herein as a reference. A light component transmitted through the liquid crystal dimmer plate is controlled by controlling the scattering effect of the dimmer plate.

According to an embodiment of the invention, PDLC Film (model LR403, polymer dispersed liquid crystal film) is used for control of light transmission via incubator's wall. PDLC (Polymer Dispersed Liguid Crystal) is a light modulating material comprised of droplets of liquid crystal uniformly dispersed in a transparency or translucency, flexible plastic film. When power off, coming visible light scatters through the PDLC, and the film turns translucent; When power on, coming visible light transmits the PDLC and the Film turns clear. This smart incubator is dimmable transparency, Transparency ranges from 3% to 87%, 3.99% UV blocking.

Reference is now made to FIG. 1, illustrating in a schematic and non-limiting manner an incubator (20) with a canopy, envelope, window or wall thereof (21) which is characterized by at least one portion (10), said portion comprises, incorporated with or otherwise in connection with one or more smart incubator's glass (SIG, 1), said SIG is selected from a group consisting of electrochromic devices, suspended particle devices, polymer dispersed liquid crystal devices, micro-blinds, mechanical smart windows, nano-crystals and combination thereof adapted to at least partially reduce the light transparency via portion (10). The SIG is in connection (100) with DC power source (101), said incubator is further provided with at least one sensor (30), such as, but not limited to, a photodiode or thermometer, or any combination thereof, which converts light or temperature into electrical current. This electrical current is transmitted to a controller (102), which collects the input current provided by the sensor and further converts it to an electrical current to be transmitted to the DC power source (101), thereby increasing or decreasing the light transparency in portion (10). More than that, FIG. 1 presents an incubator useful for eliminating visual pathway sequelae or retinopathy of prematurity (ROP) in premature (2) which was exposed to continuous lighting of its surroundings, especially the ambient NICU (22) illumination thereby adversely affecting the rest-activity patterns of newborn (2); incubator (20) is operative by a method consisting steps of providing at least one portion (10) of a premature incubators with an SIG (1)-containing light-dimmable transparent canopy, envelope, window or wall thereof (21), accommodating the premature within said incubator, further providing at least one sensor (30), such as, but not limited to a photodiode or a thermometer or any combination thereof, for converting light or temperature to an electrical current, transmitting the electrical current to a controller (102), which collects the input current provided by the sensor and further converts it to an electrical current to be transmitted to the DC power source, thereby increasing or decreasing the light transparency in portion (10) as required, such that sequelae or ROP is eliminated whilst prelature's rest is provided.

Hence for example, according to an embodiment of the invention, a liquid crystal cell (LC) as defined in EP 0331462 B1 (incorporated herein as a reference) is utilized as a SIG in premature's incubator's canopies. The LC comprising a liquid crystal material confined between a first optically-transparent substrate and a second optically-transparent substrate arranged opposite to each other, with electrode means provided on the respective opposed inward facing surfaces thereof, characterized in that said first substrate is of a semi-insulating crystalline material and said electrode means on the inward facing surface of said first substrate includes a region in which ions are implanted to cause electrical conductivity.

According to another embodiment of the invention, a liquid crystal cell (LC) as defined in U.S. Pat. No. 6,369,870 (incorporated herein as a reference) is utilized as an SIG in neonate's chart utilized in both hospitals and in in-house purposes. The reflective type liquid crystal display device comprises a liquid crystal sandwiched between first and second substrates, a transparent electrode and a reflective electrode for driving the liquid crystal formed on the mutually opposed inside faces of the respective substrates, and a polarizing plate formed on the outside faces of the substrates having the transparent electrode, wherein the liquid crystal in an initial align state has its optical axis controlled into directions of the normal lines of the substrates. A polarization axis direction of the polarizing plate is designed to form an angle of 45 degrees with respect to azimuth of the optical axis of the liquid crystal when a voltage for driving the liquid crystal is applied between the electrodes. The transparent electrode comprises an orientation control window which is formed at the center or to extend along a diagonal line of the reflective electrode. The window fixes disclination of the orientation of the liquid crystal controlled into the directions which are different on respective sides of the reflective electrode to stabilize the orientation of the liquid crystal as the whole. The orientation of the liquid crystal can be more accurately controlled by an orientation control electrode disposed around the reflective electrode.

According to yet another embodiment of the invention, a transparency adjustment system as defined in US2013188105 (incorporated herein as a reference) is utilizable as a SIG in connection with at least partially transparent canopies of baby's incubators. This transparency adjustment system comprises a transparent physical element whose electrical behavior is that of a capacitive load; and power dimmer apparatus operative to provide AC current to the transparent physical element to generate a set of transparency states including a plurality of transparency states other than full transparency.

According to an embodiment of the invention, an optically adjustable screen as defined in WO2001001191, which is incorporated herein as a reference, is used as an SIG. The optically adjustable screen comprising at least two layers of glass or transparent synthetic material which are provided with a layer of electrically conductive transparent material, and whereby a layer of liquid crystals is provided between the above-mentioned layers whose optical characteristics, in particular the transparency can be adjusted between a transparent condition and a non-transparent condition of the screen. At least one of the above-mentioned electrically conductive layers is subdivided in at least two zone-switch are separated from one another, whereby each of the above-mentioned zones is electrically connected to a power source and a switch is provided in at least one zone connection.

According to an embodiment of the invention, a microblind system as defined in US 20060196613, which is incorporated herein as a reference, is used as an SIG for shading light via canopy's wall of incubator. A microblind system has an array of overhanging stressed microblinds, each having an anchor portion attached a substrate and a mobile portion. The microblinds are responsive to electrostatic forces to mutate between a deployed configuration wherein the mobile portion obscure the substrate and a curled configuration wherein the mobile portion exposes the substrate. A transparent conductive layer permits the application of an electric field to the microblinds. The microblind system comprising: an array of stressed microblinds, each having an anchor portion attached a substrate in the form of a window, illuminated panel, or supporting layer to be applied to a window or illuminating panel, and an overhanging mobile portion; said microblinds being responsive to electrostatic forces to mutate between a deployed configuration wherein said overhanging mobile portion obscures the substrate and a curled configuration wherein said overhanging mobile portion exposes the substrate; and a transparent conductive layer for applying an electric field to said microblinds.

What is claimed is:

1. An incubator for dimming and undimming the light transmitted therein its capacity comprising:
a. at least one sensor configured to detect light transmitted into said incubator's capacity and to further convert said transmitted light into electrical current; and
b. a canopy characterized by at least one portion, said portion comprises one or more smart incubator's glass (SIG);
wherein said SIG is adapted to at least partially reduce or increase the light transparency via said portion in accordance with said sensor's electrical current.

2. The incubator according to claim 1 wherein said sensor is configured to detect light in the range of visible light.

3. The incubator according to claim 1 wherein said sensor is further provided with a semi-permeable light filter.

4. The incubator according to claim 1 wherein said SIG is selected from a group consisting of electrochromic devices, suspended particle devices, polymer dispersed liquid crystal devices, micro-blinds, mechanical smart windows, nano-crystals and any combination thereof.

5. The incubator according to claim 4 wherein said incubator is useful for eliminating visual pathway sequelae or retinopathy of prematurity (ROP) in a premature which was exposed to continuous lighting thereby adversely affecting the rest-activity patterns of the newborn.

6. The incubator according to claim 4 wherein said incubator is operative by a method consisting steps of providing at least one photodiode configured to detect light transmitted into said incubator and to further convert said transmitted light into electrical current; and at least one portion of a premature incubator with a SIG-containing light-dimmable transparent canopy, envelope, window or wall thereof, accommodating a premature within said incubator, and dimming or undimming the light transparency in said portion in accordance with said electrical current such that sequelae or ROP is eliminated whilst the premature's rest is acquired.

7. A method of dimming and undimming the light within an incubator, comprising reducing the light transparency of at least a portion of said incubator's canopy by providing said portion with one or more smart incubator's glass (SIG), and further providing a sensor detecting light transmitted into said incubator and converting said transmitted light into an electrical current, resulting in an alteration of electrical input supplied to said SIG, affecting the transparency of said portion, thereby dimming and undimming the light within said incubator.

8. The method according to claim 7 wherein said sensor is configured to detect light in the range of visible light.

9. The method according to claim 7 wherein said sensor is further provided with a semi-permeable light filter.

10. The method according to claim 7 further provided with selecting said SIG from a group consisting of electrochromic devices, suspended particle devices, polymer dispersed liquid crystal devices, micro-blinds, mechanical smart windows, nano-crystals and any combination thereof.

11. The method according to claim 7 whereby said method is directed at eliminating visual pathway sequelae or retinopathy of prematurity (ROP), in a premature which was exposed to continuous lighting thereby adversely affecting the rest-activity patterns of the newborn; the method further comprises steps of accommodating a premature within said incubator, and dimming the light transparency in said portion as required such that sequelae or ROP is eliminated whilst premature's rest is acquired.

12. A system comprising of:
a. at least one sensor configured to detect light transmitted into said incubator and further convert said transmitted light into electrical current; and
b. a canopy characterized by at least one portion, said portion comprises one or more smart incubator's glass (SIG);
wherein said SIG is adapted to at least partially reduce or increase the light transparency via said portion in accordance with said electrical current.

13. The system according to claim 12 wherein said sensor is configured to detect light in the range of visible light.

14. The system according to claim 12 wherein said sensor is further provided with a semi-permeable light filter.

15. The system according to claim 12 wherein said SIG is selected from a group consisting of electrochromic devices, suspended particle devices, polymer dispersed liquid crystal devices, micro-blinds, mechanical smart windows, nano-crystals and any combination thereof.

16. An incubator for reducing or increasing heat therein its capacity comprising:
a. at least one sensor configured to measure temperature and to further convert said measured temperature into electrical current; and
b. a canopy characterized by at least one portion, said portion comprises one or more smart incubator's glass (SIG);
wherein said SIG is adapted to at least partially reduce or increase the light transparency via said portion in accordance with said sensor's electrical current.

17. The incubator according to claim 16 wherein said sensor is a skin temperature sensor.

18. The incubator according to claim 16 wherein said sensor is an incubator's capacity temperature sensor.

19. The incubator according to claim 16 wherein said SIG is selected from a group consisting of electrochromic devices, suspended particle devices, polymer dispersed liquid crystal devices, micro-blinds, mechanical smart windows, nano-crystals and any combination thereof.

20. The incubator according to claim 19 wherein the heat overshoot in the incubator's capacity due to alterations in light transparency does not exceed 2° C. in accordance with ANSI/AAMI/IEC 60601-2-20:2009.

21. A method of reducing or increasing the heat within an incubator, reducing or increasing the light transparency of at least a portion of said incubator's canopy, comprising providing said portion with one or more smart incubator's glass (SIG); further providing a sensor for measuring temperature, and converting said measured temperature into an electrical current, resulting in an alteration of electrical input supplied to said SIG, affecting the transparency of said portion, thereby reducing or increasing the heat within said incubator.

22. The method according to claim 21 further provided with selecting said SIG from a group consisting of electrochromic devices, suspended particle devices, polymer dispersed liquid crystal devices, micro-blinds, mechanical smart windows, nano-crystals and any combination thereof.

23. An incubator for dimming and undimming the light transmitted therein its capacity comprising:
a. at least one sensor configured to detect light transmitted into said incubator's capacity and to further convert said transmitted light into electrical current; and,
b. a canopy characterized by at least one portion, said portion comprises one or more smart incubator's glass (SIG);
wherein said SIG is adapted to at least partially reduce or increase the light transparency via said portion in accordance with said sensor's electrical current.
